(19) United States
(12) Patent Application Publication
(10) Pub. No.: US 2021/0003072 A1
(43) Pub. Date: Jan. 7, 2021

(54) ROTARY INTERNAL COMBUSTION ENGINE

(71) Applicant: LOOK FOR THE POWER, LLC, Irmo, SC (US)

(72) Inventor: John A. Saavedra, Irmo, SC (US)

(21) Appl. No.: 17/040,770

(22) PCT Filed: Dec. 4, 2018
(86) PCT No.: PCT/US2018/063733

§ 371 Date: Sep. 23, 2020

(51) Int. Cl. F02C 5/12; F23R 7/00

(52) U.S. Cl. CPC F02C 5/12; F02C 5/02; F23R 7/00

(57) ABSTRACT

An engine having a compressor for generating a flow of pressurized oxidizer, a fuel mixing system in fluid communication with the compressor for mixing fuel with the pressurized oxidizer creating a fuel-oxidizer mixture, a combustion chamber adapted to receive the fuel-oxidizer mixture, at least one ignition system connected to the combustion chamber for igniting the fuel-oxidizer mixture inside of the combustion chamber, an exhaust port in fluid communication with the combustion chamber for receiving exhaust generated by combustion of the fuel-oxidizer mixture, and a turbine having a rotating shaft and a plurality of turbine blades connected downstream of the combustion chamber for receiving the exhaust whereby the fluid force of the exhaust through the exhaust port causes the turbine blades to rotate the shaft.

### TECHNICAL FIELD AND BACKGROUND OF THE INVENTION

This invention relates to combustion engines. More particularly, the invention relates to internal combustion engines that produce rotary motion from the power generated by igniting a pressurized mixture of fuel and oxidizer.

Generating rotary movement is ideal in transportation applications such as vehicles, boats, aircraft and locomotives, as well as other industrial applications such as power generation, gas compression, or mechanical drives. Historically, the internal combustion engines are of two types: continuous or intermittent combustion.

Internal combustion engines with continuous combustion are characterized by having a constant, continuous combustion of fuel and oxidizer. Examples of internal combustion engines with continuous combustion are gas turbines, jet engines, steam engines and boilers. Many continuous internal combustion engines are able to directly convert the combustion energy into rotary motion which is extremely beneficial. While many of these have specific useful applications such as aviation and power generation, they are fraught with challenges when it comes to other industrial and transportation applications. While both gas turbines and jet engine concepts have been implemented into motor vehicles, the technical, cost, and efficiency challenges have prevented this technology from resulting in mass production and use. The power to weight ratio and overall efficiency, especially when scaled down, of gas turbines is especially problematic for vehicles designed for use by an average consumer. Further safety concerns over foreign debris being sucked into the turbine and the exhaust heat also prevent these types of engines from use on vehicles.

Internal combustion engines with intermittent combustion are characterized by a succession of thermodynamic events to fill and pressurize the space where ignition and combustion will occur. While this cycle repeats, the ignition is not constant, but instead operates on a cycle. Internal combustion engines with intermittent combustion form two subsets: piston engines such as the two and four cycle engines, and rotary engines such as the Wankel engine.

Conventional reciprocating piston engines are one of the most widely used engines due to their application of land-based vehicle transportation. These engines operate with pistons and a crankshaft converting the combustion energy into linear, reciprocating mechanical motion and finally into rotary mechanical motion. Much of the energy generated by the combustion is ultimately wasted and lost in the process of converting reciprocating linear motion to the rotary motion of a shaft. The conversion of linear, reciprocating motion into rotary motion limits the speeds that may be achieved. These engines have numerous moving parts that need to be maintained and replaced as normal wear and tear occurs. Other weaknesses such as vibration and noise exist as well.

Modern rotary engines like the Wankel engine have been the subject of much research and development efforts since the 1950's. The concept is to use intermittent combustion to produce continuous rotary motion. The fundamental design is an eccentric oval-like housing containing three chambers and an eccentric three-sided rotor, the rotor turning when combustion occurs in the chambers. Having a pistonless engine that produces rotary motion directly from intermittent combustion has many advantages over piston engines, such as a higher power to weight ratio, smaller overall footprints, no reciprocating parts, ability to achieve higher revolutions per minute, and operating with much less vibration. However, while the concept has had limited success, many issues have plagued the concept and prevented mass conversion from the traditional piston engines used in vehicles. Difficulty sealing between the chambers, slow combustion due to the non-uniform shape of the chambers, and movement of the chambers causing an uneven burning are problems that result in poor fuel economy and high emissions. There is currently little, if any, developmental work or manufacturing worldwide on the Wankel rotary engine.

There is a need in the art for a pistonless, low-friction rotary engine, utilizing intermittent, internal combustion to produce rotary motion of a shaft.

### SUMMARY OF THE INVENTION

It is therefore an object of the present invention to provide a pistonless, low-friction rotary engine, utilizing intermittent internal combustion to produce rotary motion of a shaft.

These and other objects and advantages of the present invention are achieved in the exemplary embodiments set forth below by providing an engine having a compressor for generating a flow of pressurized oxidizer, a fuel mixing system in fluid communication with the compressor for mixing fuel with the pressurized oxidizer creating a fuel-oxidizer mixture, a combustion chamber adapted to receive the fuel-oxidizer mixture, at least one ignition system connected to the combustion chamber for igniting the fuel-oxidizer mixture inside of the combustion chamber, an exhaust port in fluid communication with the combustion chamber for receiving exhaust generated by combustion of the fuel-oxidizer mixture, and a turbine having a rotating shaft and a plurality of turbine blades connected downstream of the combustion chamber for receiving the exhaust whereby the fluid force of the exhaust through the exhaust port causes the turbine blades to rotate the shaft.

According to another embodiment of the invention, a generator is in communication with the turbine and adapted to generate power from the rotation of the shaft and provide power to the compressor.

According to another embodiment of the invention, the fuel mixing system is a venturi.

According to another embodiment of the invention, the fuel-oxidizer mixture enters the combustion chamber through an entrance device that prevents pressurized exhaust from flowing backward into the compressor.

According to another embodiment of the invention, the ignition system is a spark plug.

According to another embodiment of the invention, the ignition system includes a plurality of spark plugs with a predetermined firing sequence.

According to another embodiment of the invention, the exhaust port includes a pressure relief valve and an exhaust conduit for transporting the exhaust to the turbine.

According to another embodiment of the invention, the exhaust port is connected to an exhaust conduit that includes a nozzle for the exhaust to exit and apply fluid pressure to the turbine blades.

According to another embodiment of the invention, the combustion chamber includes a plurality of exhaust ports in fluid communication with the turbine.

According to another embodiment of the invention, the fuel-oxidizer mixture is transported to a plurality of combustion chambers each including at least one exhaust port in fluid communication with the turbine.

According to another embodiment of the invention, the turbine shaft includes a plurality of turbine blade stages.

According to another embodiment of the invention, the engine has at least one additional turbine connected downstream of the combustion chamber for receiving the exhaust.

According to another embodiment of the invention, a flywheel is connected to the turbine.

According to another embodiment of the invention, a second comparatively smaller engine is connected downstream of the turbine for capturing additional energy including: a second combustion chamber adapted to receive the pressurized exhaust, a second ignition system connected to the second combustion chamber for igniting the exhaust inside of the second combustion chamber, a second exhaust port in fluid communication with the second combustion chamber for receiving exhaust generated by combustion of the fuel-oxidizer mixture, and a second turbine having a second rotating shaft and a second plurality of turbine blades connected downstream of the second combustion chamber for receiving the exhaust whereby the fluid force of the exhaust through the second exhaust port causes the second turbine blades to rotate the second turbine shaft.

According to another embodiment of the invention, the second engine has a second compressor positioned between the turbine and the second combustion chamber adapted to receive the exhaust from the turbine and generate a flow of pressurized exhaust.

According to another embodiment of the invention, an engine is provided comprising: a compressor including a pressure-producing portion and a reservoir portion for generating a flow of pressurized oxidizer, a fuel mixing system positioned between the pressure-producing portion and the reservoir portion of the compressor for mixing fuel with an oxidizer to create a fuel-oxidizer mixture inside of the reservoir portion, a combustion chamber adapted to receive the fuel-oxidizer mixture from the reservoir portion of the compressor, at least one ignition system connected to the combustion chamber for igniting the fuel-oxidizer mixture inside of the combustion chamber, an exhaust port in fluid communication with the combustion chamber for receiving exhaust generated by combustion of the fuel-oxidizer mixture, and a turbine having a rotating shaft and a plurality of turbine blades connected downstream of the combustion chamber for receiving the exhaust whereby the fluid force of the exhaust through the exhaust port causes the turbine blades to rotate the shaft.

According to another embodiment of the invention, an engine is provided, comprising: a compressor for generating a flow of pressurized oxidizer, a combustion chamber adapted to receive the pressurized oxidizer, a fuel mixing system in communication with the combustion chamber for injecting fuel into the combustion chamber filled with the pressurized oxidizer creating a pressurized fuel-oxidizer mixture, an exhaust port in fluid communication with the combustion chamber for receiving exhaust generated by combustion of the fuel-oxidizer mixture, a turbine having a rotating shaft and a plurality of turbine blades connected downstream of the combustion chamber for receiving the exhaust whereby the fluid force of the exhaust through the exhaust port causes the turbine blades to rotate the shaft, and whereby the pressurized fuel-oxidizer mixture is ignited by heat produced due to compression once a pre-determined temperature or pressure is reached inside of the combustion chamber.

According to another embodiment of the invention, the fuel mixing system is controlled by a combustion timing system based on temperature and pressure inputs from the combustion chamber.

According to another embodiment of the invention, the combustion timing can be done by an electric timing system, mechanical timing system, or a vacuum timing system. Electric timing systems can be based on a mechanical timing system. Examples of an electric timing system can include a computer that takes inputs such as duration of time, pressure inside of a combustion chamber, rotational speed of the rotor, temperature of the combusted exhaust, oxidizer volume leaving the compressor, and volume of fuel delivered. Mechanical timing systems can include belts, gears, or other suitable means of timing the ignition.

According to another embodiment of the invention, cooling systems are included to reduce the temperature of any of the elements of the invention. Cooling systems can be included in or around the combustion chamber, the exhaust valve, the exhaust conduit, the nozzle, the rotor shaft, and the turbine blades. Examples of cooling systems include liquid cooling, air cooling, evaporative cooling, coils, and heat exchangers.

According to another embodiment of the invention, the engine can operate on diesel fuel or a similar type of fuel that achieves ignition and combustion based on pressure rather than requiring a separate ignition system.

### BRIEF DESCRIPTION OF THE DRAWING FIGURES

The present invention is best understood when the following detailed description of the invention is read with reference to the accompanying drawings, in which:

FIG. 1 is a schematic of the engine according to an embodiment of the invention;

FIG. 2 is a schematic of the engine according to an alternative embodiment of the invention;

FIG. 3 is a partial schematic of the engine showing an alternative multiple spark plug combustion chamber configuration;

FIG. 4 is a partial schematic of the engine showing an alternative multiple combustion chamber configuration;

FIG. 5 is a partial schematic of the engine showing an alternative turbine shaft with a plurality of turbine blade stages; and

FIG. 6 is a partial schematic of the engine connected to a comparatively smaller engine.

### DETAILED DESCRIPTION OF THE EXEMPLARY EMBODIMENT

The present discussion is a description of exemplary embodiments only and is not intended as limiting the broader aspects of the present invention. The following example is provided to further illustrate the invention and is not to be construed to unduly limit the scope of the invention.

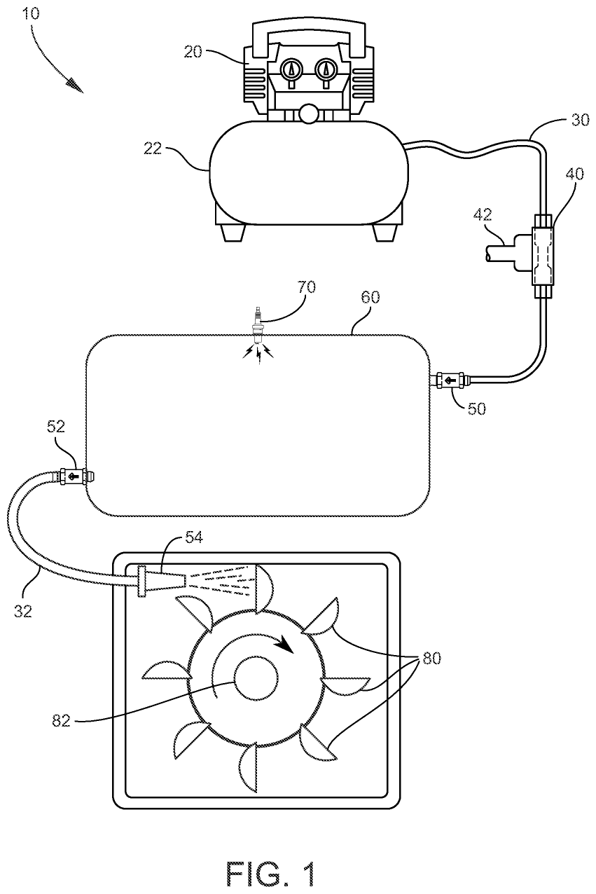

Referring to the drawings where identical reference numerals denote the same elements throughout the various views, FIG. 1 shows the engine 10. The engine 10 includes an air compressor made up of a pressure-producing portion 20 and a reservoir portion 22. The air compressor 20,22 utilizes traditional reciprocating piston technology, however other air compressor technologies are also applicable. The air compressor 20,22 provides compressed air, or any acceptable oxidizer, to a first conduit 30. The first conduit 30 includes a venturi 40 where fuel is mixed with the air to create a fuel-air mixture. Fuel is inserted into the venturi 40 through a fuel inlet 42. Examples of fuel include gasoline, kerosene, alcohol, ethanol, diesel oil, and used cooking oil. The venturi 40 can be a traditional carburetor such as one used in a lawn mower or motor vehicle.

The fuel-air mixture travels through the rest of the first conduit 30 and into a combustion chamber 60 by way of an entrance valve 50. In the exemplary embodiment, the entrance valve 50 is illustrative of one of several possible designs to keep the pressure from combustion from backing up into the compressor. Once the fuel-air mixture is inside of the combustion chamber 60, a spark plug 70 ignites the mixture inside of the combustion chamber 60. Other types of ignition systems, such as a laser igniter, can also be used instead of the spark plug 70.

Exhaust gases generated by the combustion of the fuel-air mixture then exit out of the combustion chamber 60 through an exit valve 52 and into a second conduit 32. The exit valve 52 serves to insure the force of the combustion is directed outside of the combustion chamber 60. Examples include a simple one-way check valve, electronic or spring controlled valves, and other devices that serve this pressure relief function. The gases then exit the second conduit 32 through a nozzle 54 directed toward turbine blades 80 attached to a turbine rotating shaft 82. The fluid force generated by the combustion exhaust cause the turbine blades 80 to rotate the turbine shaft 82. The rotation of the turbine shaft 82 can be used to provide the rotation needed for wheels on a vehicle, a belt, a chain, gears, and many other applications. A generator, such as an electrical generator, can also be powered by the turbine shaft 82 in order to provide power to the compressor 20,22.

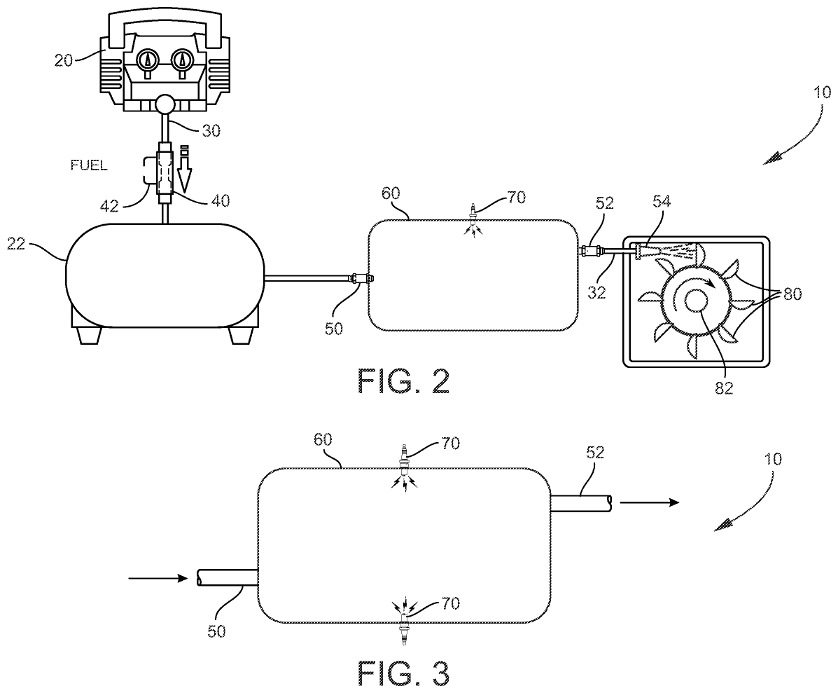

FIG. 2 shows an alternative variation of the engine 10 where the venturi 40 is located between the pressure-producing portion 20 and the reservoir portion 22 of the air compressor 20,22. In this alternative, the entire first conduit 30 transports the fuel-air mixture from the reservoir portion 22 through the entrance valve 50 into the combustion chamber 60.

FIG. 3 shows an alternative variation of the engine 10 where the combustion chamber 60 has a plurality of spark plugs 70. These spark plugs 70 are connected and ignite the fuel-air mixture based upon a firing sequence. This sequence is determined based upon the location of the spark plugs 70, the volume of the combustion chamber 60, the pressure of the fuel-air mixture inside of the combustion chamber 60, and many other variables. The sequence can be pre-determined, or calculated in real-time by a controller (not shown).

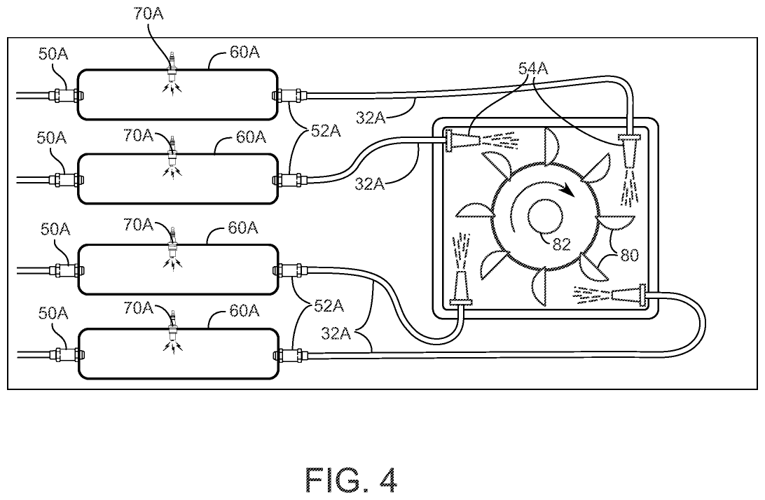

FIG. 4 shows an alternative variation of the engine 10 where the combustion chamber 60 is made up of a plurality of separate combustion chambers 60A each having a spark plug 70A, an entrance valve 50A, and an exit valve 52A. Each exit valve 52A is in fluid communication with a separate exhaust conduit 32A. The exhaust gases pass through the separate exhaust conduits 32A and exit through separate nozzles 54A to ultimately exert a fluid force on different blades 80 on the turbine shaft 82. While FIG. 4 shows four separate combustion chambers 60A of equal size, the arrangement and relative sizes of each separate combustion chamber 60A can vary.

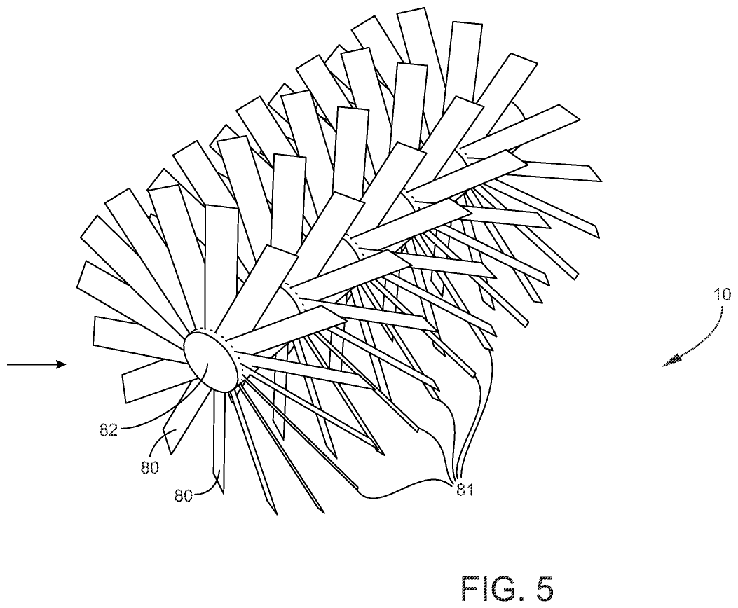

FIG. 5 shows an alternative variation of the engine 10 where the turbine shaft 82 has a plurality of turbine blade stages 81. Each of these turbine blade stages 81 can receive the fluid force of combustion exhaust to rotate the turbine shaft 82. This can be achieved by either dividing the exhaust conduit 32 as shown in FIGS. 1 and 2, or by the separate exhaust conduits 32A from the multiple combustion chambers 60A configuration as shown in FIG. 4. Each turbine blade stage 81 has the same number of blades 80, however alternative embodiments can have varying amounts of blades 80 per stage 81 for optimization purposes. For example, the number of blades 80 per turbine blade stage 81 can be reduced going downstream from the nozzle 54.

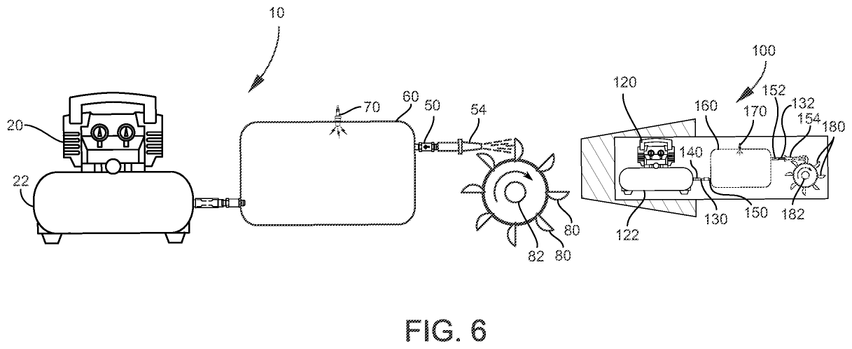

As shown in FIG. 6, another, comparatively smaller engine 100 can be positioned to capture additional energy in the combustion exhaust after the combustion exhaust has exited the engine 10. This smaller engine 100 also has a compressor 120,122, a first conduit 130, a venturi 140, an entrance valve 150, a combustion chamber 160, a spark plug 170, an exit valve 152, a exhaust conduit 132, a nozzle 154, and a turbine shaft 182 having a plurality of turbine blades 180.

An engine according to the invention has been described with reference to specific embodiments and examples. Various details of the invention may be changed without departing from the scope of the invention. Furthermore, the foregoing description of the exemplary embodiments of the invention and best mode for practicing the invention are provided for the purpose of illustration only and not for the purpose of limitation, the invention being defined by the claims.

1. An engine, comprising:
(a) a compressor for generating a flow of pressurized oxidizer;
(b) a fuel mixing system in fluid communication with the compressor for mixing fuel with the pressurized oxidizer creating a fuel-oxidizer mixture;
(c) a combustion chamber adapted to receive the fuel-oxidizer mixture;
(d) at least one ignition system connected to the combustion chamber for igniting the fuel-oxidizer mixture inside of the combustion chamber;
(e) an exhaust port in fluid communication with the combustion chamber for receiving exhaust generated by combustion of the fuel-oxidizer mixture;
(f) a turbine having a rotating shaft and a plurality of turbine blades connected downstream of the combustion chamber for receiving the exhaust whereby the fluid force of the exhaust through the exhaust port causes the turbine blades to rotate the shaft; and
(g) a generator in communication with the turbine and adapted to generate power from the rotation of the shaft and provide power to the compressor.

2. (canceled)

3. An engine according to claim 1, wherein the fuel mixing system is a venturi.

4. An engine according to claim 1, wherein the fuel-oxidizer mixture enters the combustion chamber through an entrance device that prevents pressurized exhaust from flowing backward into the compressor.

5. An engine according to claim 1, wherein the ignition system is a spark plug.

6. An engine according to claim 1, wherein the ignition system includes a plurality of spark plugs with a predetermined firing sequence.

7. An engine according to claim 1, wherein the exhaust port includes a pressure relief valve and an exhaust conduit for transporting the exhaust to the turbine.

8. An engine according to claim 1, wherein the exhaust port is connected to an exhaust conduit that includes a nozzle for the exhaust to exit and apply fluid pressure to the turbine blades.

9. An engine according to claim 1, wherein the combustion chamber includes a plurality of exhaust ports in fluid communication with the turbine.

10. An engine according to claim 1, wherein the fuel-oxidizer mixture is transported to a plurality of combustion chambers each including at least one exhaust port in fluid communication with the turbine.

11. An engine according to claim 1, wherein the turbine shaft includes a plurality of turbine blade stages.

12. An engine according to claim 1, further comprising at least one additional turbine connected downstream of the combustion chamber for receiving the exhaust.

13. An engine according to claim 1, further comprising a flywheel connected to the turbine.

14. An engine according to claim 1, further comprising a second comparatively smaller engine connected downstream of the turbine for capturing additional energy including:
(a) a second combustion chamber adapted to receive the pressurized exhaust;
(b) a second ignition system connected to the second combustion chamber for igniting the exhaust inside of the second combustion chamber;
(c) a second exhaust port in fluid communication with the second combustion chamber for receiving exhaust generated by combustion of the fuel-oxidizer mixture; and
(d) a second turbine having a second rotating shaft and a second plurality of turbine blades connected downstream of the second combustion chamber for receiving the exhaust whereby the fluid force of the exhaust through the second exhaust port causes the second turbine blades to rotate the second turbine shaft.

15. An engine according to claim 14, wherein the second engine has a second compressor positioned between the turbine and the second combustion chamber adapted to receive the exhaust from the turbine and generate a flow of pressurized exhaust.

16. An engine, comprising:
(a) a compressor including a pressure-producing portion and a reservoir portion for generating a flow of pressurized oxidizer;
(b) a fuel mixing system positioned between the pressure-producing portion and the reservoir portion of the compressor for mixing fuel with an oxidizer to create a fuel-oxidizer mixture inside of the reservoir portion;
(c) a combustion chamber adapted to receive the fuel-oxidizer mixture from the reservoir portion of the compressor;
(d) at least one ignition system connected to the combustion chamber for igniting the fuel-oxidizer mixture inside of the combustion chamber;
(e) an exhaust port in fluid communication with the combustion chamber for receiving exhaust generated by combustion of the fuel-oxidizer mixture; and
(f) a turbine having a rotating shaft and a plurality of turbine blades connected downstream of the combustion chamber for receiving the exhaust whereby the fluid force of the exhaust through the exhaust port causes the turbine blades to rotate the shaft.

17. An engine, comprising:
(a) a compressor for generating a flow of pressurized oxidizer;
(b) a combustion chamber adapted to receive the pressurized oxidizer;
(c) a fuel mixing system in communication with the combustion chamber for injecting fuel into the combustion chamber filled with the pressurized oxidizer creating a pressurized fuel-oxidizer mixture;
(d) an exhaust port in fluid communication with the combustion chamber for receiving exhaust generated by combustion of the fuel-oxidizer mixture;
(e) a turbine having a rotating shaft and a plurality of turbine blades connected downstream of the combustion chamber for receiving the exhaust whereby the fluid force of the exhaust through the exhaust port causes the turbine blades to rotate the shaft; and
(f) whereby the pressurized fuel-oxidizer mixture is ignited by heat produced due to compression once a pre-determined temperature or pressure is reached inside of the combustion chamber.

18. An engine according to claim 17, wherein the fuel mixing system is controlled by a combustion timing system based on temperature and pressure inputs from the combustion chamber.
